(19) United States
(12) Patent Application Publication
(10) Pub. No.: US 2019/0147052 A1
(43) Pub. Date: May 16, 2019

(54) METHOD AND APPARATUS FOR PLAYING MULTIMEDIA

(71) Applicant: Baidu Online Network Technology (Beijing) Co., Ltd., Beijing (CN)

(72) Inventors: Guang LU, Beijing (CN); Shiquan YE, Beijing (CN); Xiajun LUO, Beijing (CN); Lei SHI, Beijing (CN)

(21) Appl. No.: 15/856,850

(22) Filed: Dec. 28, 2017

(30) Foreign Application Priority Data
Nov. 16, 2017 (CN) 201711138844.2

(51) Int. Cl. G06F 17/30; G10L 15/22; G10L 15/18; G06F 3/16

(52) U.S. Cl. CPC G06F 17/30026; G06F 17/3005; G10L 2015/223; G10L 15/1815; G06F 3/165; G10L 15/22

(57) ABSTRACT

The embodiments of the disclosure disclose a method and apparatus for playing multimedia. An embodiment of the method comprises: receiving a voice playing request inputted by a user; matching between a lexeme of the voice playing request and a semantic slot to obtain semantic slot information of the request; determining, based on a result of matching between multimedia in a multimedia database and the semantic slot information of the request, multimedia used for playing, and feeding back reply information to the voice playing request by voice; and playing the multimedia used for playing. The embodiment improves the accuracy of the voice interaction and the accuracy and pertinence in playing multimedia.

### CROSS-REFERENCE TO RELATED APPLICATIONS

This application is related to and claims priority from Chinese Patent Application No. 201711138844.2, filed with the State Intellectual Property Office (SIPO) of the People's Republic of China on Nov. 16, 2017, the entire disclosure of which is hereby incorporated by reference.

### TECHNICAL FIELD

This disclosure relates to the field of computer technology, specifically to the field of computer networking technology, and more specifically to a method and apparatus for playing multimedia.

### BACKGROUND

With the advent of the network era, increasingly more users are inclined to accept intelligent service. Taking audio-visual service as an example, smart terminals are expected to understand users' voice input, and provide the users with personalized audio-visual services based on the understanding of the user voice.

At present, in an audio-visual voice interaction scenario using smart terminals, the terminals may meet any on-demand play request when responding to a user's voice input, and change the content of the currently played multimedia based on the understanding of the user's voice.

### SUMMARY

An object of the disclosure is to provide a method and apparatus for playing multimedia.

In a first aspect, an embodiment of the disclosure provides a method for playing multimedia, including: receiving a voice playing request inputted by a user; matching between a lexeme of the voice playing request and a semantic slot to obtain semantic slot information of the request; determining, based on a result of matching between multimedia in a multimedia database and the semantic slot information of the request, multimedia used for playing, and feeding back reply information to the voice playing request by voice; and playing the multimedia used for playing.

In some embodiments, the determining, based on a result of matching between multimedia in a multimedia database and the semantic slot information of the request, multimedia used for playing, and feeding back reply information to the voice playing request by voice includes: determining, in response to completely matching between the multimedia in the multimedia database and the semantic slot information of the request and based on the multimedia completely matching the semantic slot information of the request, the multimedia used for playing, and feeding back the reply information to the voice playing request and/or recommendation information of the multimedia used for playing by voice.

In some embodiments, the determining, based on a result of matching between multimedia in a multimedia database and the semantic slot information of the request, multimedia used for playing, and feeding back reply information to the voice playing request by voice includes: determining, in response to partially matching between the multimedia in the multimedia database and the semantic slot information of the request and based on a comprehensive priority of the matched semantic slot, the multimedia used for playing from the multimedia partially matching the semantic slot information of the request, and feeding back guiding reply information to the voice playing request and/or recommendation information of the multimedia used for playing by voice based on the matched semantic slot, unmatched semantic slot and selected multimedia.

In some embodiments, the determining, based on a result of matching between multimedia in a multimedia database and the semantic slot information of the request, multimedia used for playing, and feeding back reply information to the voice playing request by voice includes: determining, in response to no matching between the multimedia in the multimedia database and the semantic slot information of the request and an expression of the voice playing request failing to comply with a predetermined rule, a non-existence of multimedia used for playing and feeding back instructing reply information on the expression of the voice playing request by voice.

In some embodiments, the determining, based on a result of matching between multimedia in a multimedia database and the semantic slot information of the request, multimedia used for playing, and feeding back reply information to the voice playing request by voice includes: determining, in response to no exactly matching between the multimedia in the multimedia database and the semantic slot information of the request and based on inferred semantic slot information obtained from the semantic slot information of the request, the multimedia used for playing, and feeding back inferred reply information to an expression of the voice playing request and/or recommendation information of the multimedia used for playing by voice.

In some embodiments, the determining, based on a result of matching between multimedia in a multimedia database and the semantic slot information of the request, multimedia used for playing, and feeding back reply information to the voice playing request by voice includes: determining, in response to matching between the multimedia in the multimedia database and a partial slot in the semantic slot information of the request and a last semantic slot in the semantic slot information of the request being an unsupported semantic slot, or in response to no matching between the multimedia in the multimedia database and the semantic slot information of the request and the semantic slot information of the request comprising an unsupported semantic slot, a non-existence of multimedia used for playing, and feeding back last-ditch reply information to the voice playing request by voice.

In some embodiments, the determining, based on a result of matching between multimedia in a multimedia database and the semantic slot information of the request, multimedia used for playing, and feeding back reply information to the voice playing request by voice includes: determining, in response to a probability of similarity matching between the multimedia in the multimedia database and the semantic slot information of the request being greater than a predetermined threshold, multimedia including the probability of similarity matching between the multimedia and the semantic slot information of the request greater than the predetermined threshold being the multimedia used for playing, and feeding back, based on the semantic slot information of the request and multimedia completely matching the semantic slot information of the request, advising reply information to the voice playing request and/or recommendation information of the multimedia used for playing by voice.

In some embodiments, the determining, based on a result of matching between multimedia in a multimedia database and the semantic slot information of the request, multimedia used for playing, and feeding back reply information to the voice playing request by voice includes: determining, in response to the semantic slot information of the request comprising pieces of information satisfying a given semantic slot and based on results of individually matching between the multimedia in the multimedia database and a plurality of the semantic slots, a combination of each of the results of individually matching being the multimedia used for playing, and feeding back reply information of the combination to the voice playing request by voice.

In some embodiments, the determining, based on a result of matching between multimedia in a multimedia database and the semantic slot information of the request, multimedia used for playing, and feeding back reply information to the voice playing request by voice includes: determining, in response to the semantic slot information of the request indicating playing favorite multimedia of a user and based on historical preference data of the user, the multimedia used for playing, and feeding back one or more of the following information items by voice: the reply information to the voice playing request, recommendation information of the multimedia used for playing, and guiding information on an expression of preferences.

In some embodiments, the method further includes: feeding back, in response to a lexeme of the voice playing request not matching a semantic slot, last-ditch reply information to the voice playing request and/or instructing reply information on an expression of the voice playing request by voice.

In a second aspect, an embodiment of the disclosure provides an apparatus for playing multimedia, including: a playing request receiving unit for receiving a voice playing request inputted by a user; a semantic slot matching unit, for matching between a lexeme of the voice playing request and a semantic slot to obtain semantic slot information of the request; a multimedia determining and voice feeding back unit, for determining, based on a result of matching between multimedia in a multimedia database and the semantic slot information of the request, multimedia used for playing, and feeding back reply information to the voice playing request by voice; and a multimedia playing unit for playing the multimedia used for playing.

In some embodiments, the multimedia determining and voice feeding back unit is further used for: determining, in response to completely matching between the multimedia in the multimedia database and the semantic slot information of the request and based on the multimedia completely matching the semantic slot information of the request, the multimedia used for playing, and feeding back the reply information to the voice playing request and/or recommendation information of the multimedia used for playing by voice.

In some embodiments, the multimedia determining and voice feeding back unit is further used for: determining, in response to partially matching between the multimedia in the multimedia database and the semantic slot information of the request and based on a comprehensive priority of the matched semantic slot, the multimedia used for playing from the multimedia partially matching the semantic slot information of the request, and feeding back guiding reply information to the voice playing request and/or recommendation information of the multimedia used for playing by voice based on the matched semantic slot, unmatched semantic slot and selected multimedia.

In some embodiments, the multimedia determining and voice feeding back unit is further used for: determining, in response to no matching between the multimedia in the multimedia database and the semantic slot information of the request and an expression of the voice playing request failing to comply with a predetermined rule, a non-existence of multimedia used for playing and feeding back instructing reply information on the expression of the voice playing request by voice.

In some embodiments, the multimedia determining and voice feeding back unit is further used for: determining, in response to no exactly matching between the multimedia in the multimedia database and the semantic slot information of the request and based on inferred semantic slot information obtained from the semantic slot information of the request, the multimedia used for playing, and feeding back inferred reply information to an expression of the voice playing request and/or recommendation information of the multimedia used for playing by voice.

In some embodiments, the multimedia determining and voice feeding back unit is further used for: determining, in response to matching between the multimedia in the multimedia database and a partial slot in the semantic slot information of the request and a last semantic slot in the semantic slot information of the request being an unsupported semantic slot, or in response to no matching between the multimedia in the multimedia database and the semantic slot information of the request and the semantic slot information of the request comprising an unsupported semantic slot, a non-existence of multimedia used for playing, and feeding back last-ditch reply information to the voice playing request by voice.

In some embodiments, the multimedia determining and voice feeding back unit is further used for: determining, in response to a probability of similarity matching between the multimedia in the multimedia database and the semantic slot information of the request being greater than a predetermined threshold, multimedia including the probability of similarity matching between the multimedia and the semantic slot information of the request greater than the predetermined threshold being the multimedia used for playing, and feeding back, based on the semantic slot information of the request and multimedia completely matching the semantic slot information of the request, advising reply information to the voice playing request and/or recommendation information of the multimedia used for playing by voice.

In some embodiments, the multimedia determining and voice feeding back unit is further used for: determining, in response to the semantic slot information of the request comprising pieces of information satisfying a given semantic slot and based on results of individually matching between the multimedia in the multimedia database and a plurality of the semantic slots, a combination of each of the results of individually matching being the multimedia used for playing, and feeding back reply information of the combination to the voice playing request by voice.

In some embodiments, the multimedia determining and voice feeding back unit is further used for: determining, in response to the semantic slot information of the request indicating playing favorite multimedia of a user and based on historical preference data of the user, the multimedia used for playing, and feeding back one or more of the following information items by voice: the reply information to the voice playing request, recommendation information of the multimedia used for playing, and guiding information on an expression of preferences.

In some embodiments, the apparatus further includes: a no matching voice feeding back unit, for feeding back, in response to a lexeme of the voice playing request not matching a semantic slot, last-ditch reply information to the voice playing request and/or instructing reply information on an expression of the voice playing request by voice.

In a third aspect, an embodiment of the disclosure provides a system, including: one or more processors; and a storage device for storing one or more programs; where the one or more programs, when executed by the one or more processors, enable the one or more processors to implement the method for playing multimedia according to any one of the embodiments.

In a fourth aspect, an embodiment of the disclosure provides a computer readable storage medium storing computer programs, where the programs, when executed by a processor, enable to implement the method for playing multimedia according to any one of the embodiments.

A method and apparatus for playing multimedia provided in an embodiment of the disclosure firstly receive a voice playing request inputted by a user; match between a lexeme of the voice playing request and a semantic slot to obtain semantic slot information of the request; determine, based on a result of matching between multimedia in a multimedia database and the semantic slot information of the request, multimedia used for playing, and feeding back reply information to the voice playing request by voice; and play the multimedia used for playing. In this process, the reply information to the voice playing request may be fed back by voice and the multimedia used for playing may be played based on the voice playing request inputted by the user and based on personality identification of the user, thereby improving the accuracy of the voice interaction, and the accuracy and pertinence in playing multimedia.

### BRIEF DESCRIPTION OF THE DRAWINGS

By reading and referring to the detailed description of non-limiting embodiments provided in the accompanying drawings, other characteristics, objects and advantages of the embodiments of the disclosure will become clearer:

FIG. 1 is an architectural diagram of an illustrative system in which an embodiment of a method for playing multimedia or an apparatus for playing multimedia may be implemented;

FIG. 2 is an illustrative schematic flowchart of an embodiment of a method for playing multimedia according to the disclosure;

FIG. 3 is an illustrative schematic flowchart of an application scenario of the method for playing multimedia according to the disclosure;

FIG. 4 is an illustrative structure diagram of an embodiment of an apparatus for playing multimedia according to the disclosure; and

FIG. 5 is a structural schematic diagram of a computer system adapted to implement a terminal device or a server of the embodiments of the disclosure.

### DETAILED DESCRIPTION OF EMBODIMENTS

The present application will be further described below in detail in combination with the accompanying drawings and the embodiments. It should be appreciated that the specific embodiments described herein are merely used for explaining the relevant disclosure, rather than limiting the disclosure. In addition, it should be noted that, for the ease of description, only the parts related to the relevant disclosure are shown in the accompanying drawings.

It should also be noted that the embodiments in the present application and the features in the embodiments may be combined with each other on a non-conflict basis. The present application will be described below in detail with reference to the accompanying drawings and in combination with the embodiments.

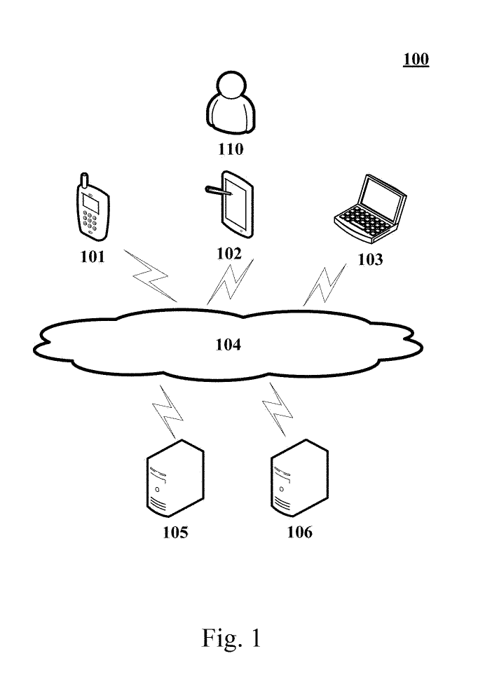

FIG. 1 shows an illustrative architecture of a system 100 which may be used by a method for playing multimedia or an apparatus for playing multimedia according to the embodiments of the present application.

As shown in FIG. 1, the system architecture 100 may include terminal devices 101, 102 and 103, a network 104 and servers 105 and 106. The network 104 serves as a medium providing a communication link between the terminal devices 101, 102 and 103 and the servers 105 and 106. The network 104 may include various types of connections, such as wired or wireless transmission links, or optical fibers.

The user 110 may use the terminal devices 101, 102 or 103 to interact with the servers 105 or 106 through the network 104, in order to transmit or receive messages, etc. Various communication client applications, such as search engine applications, shopping applications, instant messaging tools, mailbox clients, social platform software, and audio or video playing applications may be installed on the terminal devices 101, 102 or 103.

The terminal devices 101, 102 or 103 may be various electronic devices containing a display, including but not limited to, smart loudspeaker boxes, smart phones, wearable devices, tablet computers, e-book readers, MP3 (Moving Picture Experts Group Audio Layer III) players, MP4 (Moving Picture Experts Group Audio Layer IV) players, laptop computers and desktop computers.

The servers 105 or 106 may be servers providing various services, for example, back-end servers providing support for the terminal devices 101, 102 or 103. The back-end servers may perform an analysis or computing of the data of the terminal devices, and push a result of the analysis or computing to the terminal devices.

It should be noted that the method for playing multimedia according to the embodiments of the present application is generally executed by the server 105 or 106, or the terminal device 101, 102 or 103. Accordingly, an apparatus for playing multimedia is generally installed on the server 105 or 106, or the terminal device 101, 102 or 103.

It should be appreciated that the numbers of the terminal devices, the networks and the servers in FIG. 1 are merely illustrative. Any number of terminal devices, networks and servers may be provided based on the actual requirements.

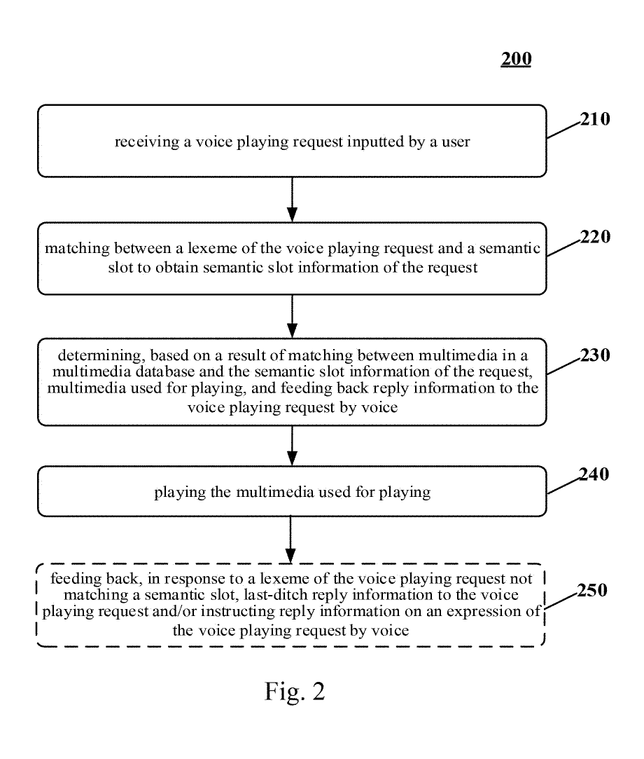

Further referring to FIG. 2, an illustrative flowchart of an embodiment of a method for playing multimedia according to the disclosure is shown.

As shown in FIG. 2, a method 200 for playing multimedia includes:

Step 210, receiving a voice playing request inputted by a user.

In this embodiment, an electronic device (e.g., a server shown in FIG. 1 or a terminal device shown in FIG. 1) on which an method for playing multimedia runs may receive a voice playing request inputted by a user through a microphone of a terminal device. The voice playing request here is used for indicating multimedia to be played by a terminal device. The multimedia content may be audio content, video content, or a combination thereof.

In some optional modes of implementing this embodiment, the receiving a voice playing request inputted by a user may include: firstly, receiving an awakening instruction inputted by a user; and then feeding back reply information by voice, and receiving a voice playing request inputted by the user.

Taking multimedia being a song in audio content as an example, a terminal device may receive a user's voice input “small A,” where the “small A” is a predetermined awakening instruction; then the terminal device sends voice feedback “OK!” to the user, and then the user inputs a voice playing request “play BB's CCC for the next one,” where “for the next one” is the moment for playing, both BB and CCC are the parameters for playing, BB is a singer name, and CCC is a song name.

Step 220, matching between a lexeme of the voice playing request and a semantic slot to obtain semantic slot information of the request.

In this embodiment, a semantic slot allows a user to describe a variable value portion of a parlance in detail, and is data that describes data. After the lexeme of a voice playing request matches the semantic slot, the semantic slot and the information filled therein are semantic slot information of the request.

Usually, a semantic plot in a voice playing request may at least include one or more of the following items: a multimedia type, a multimedia name, a creator in chief of multimedia, a list of multimedia, a list of interesting multimedia, a language, a style, a scenario, a motion, a topic, etc.

Description is made below with multimedia being a song in audio as an example. In a semantic slot, the multimedia name may be a song name; the creator in chief may be a singer, a lyricist or a composer; the list of topic multimedia may be an album; the list of interesting multimedia may be a song list; the language may be Chinese, Cantonese, English, Japanese, Korean, German, French, or other languages; the style may be pop, rock and roll, folk, electronic music, dance music, rap, light music, jazz, country music, African-American music, classical music, Chinese national music, British style, metal music, punk, blues, reggae, Latin, alternative style, new era style, ancient style, post-rock, new jazz or the like; the scenario may be early morning, night, learning, work, lunch break, afternoon tea, subway, driving, sports, travel, strolling, bar or the like; the emotion may be nostalgic, fresh, romantic, sexy, sad, healing, relaxing, lonely, touching, excited, happy, quiet, missing or the like; the topic may be: original soundtrack, cartoon, campus, game, post-70s, post-80s, post-90s, network songs, KTV, classic, cover version, guitar, piano, instrumental music, children, list, post-00s or the like.

In a specific example, taking a request for playing a song as an example, if a user's voice request is “play AA's song,” then a result of matching between a lexeme of the voice playing request and a semantic slot is: “AA” hits a semantic slot “singer,” thus obtaining semantic slot information of the request “singer: AA.”

Step 230, determining, based on a result of matching between multimedia in a multimedia database and the semantic slot information of the request, multimedia used for playing, and feeding back reply information to the voice playing request by voice.

In this embodiment, based on semantic slot information of the request, the multimedia complying with the playing parameters may be extracted from a multimedia database or network data. For example, if the semantic slot information includes “multimedia language: English,” “multimedia style: village” and “multimedia type: song,” then songs satisfying the “multimedia language: English,” “multimedia style: country,” and “multimedia type: song” may be extracted from a song database to generate a song list for playing.

After determining multimedia used for playing, the voice playing request may be replied by voice feedback, so that the user may promptly and conveniently receive feedback from the terminal device. For example, after the song list for playing is generated, feedback “OK, English country songs” may be sent to the user.

For example, an application scenario of determining, based on a result of matching between multimedia in a multimedia database and the semantic slot information of the request, multimedia used for playing, and feeding back reply information to the voice playing request by voice is described below:

In some scenarios, multimedia used for playing is determined, in response to completely matching between the multimedia in the multimedia database and the semantic slot information of the request and based on the multimedia completely matching the semantic slot information of the request, and the reply information to the voice playing request and/or recommendation information of the multimedia used for playing are fed back by voice.

For example, in response to the semantic slot information of the request “singer: XXX,” and “song name: XYZ,” obtained based on a voice playing request, multimedia used for playing is determined from multimedia completely matching the semantic slot information of the request in a multimedia database and reply information to the voice playing request “OK” and “XXX, XYZ” are fed back by voice. The multimedia used for playing may be determined from the multimedia completely matching the semantic slot information of the request based on preset selection parameters (such as a hot spot, the time to market, or a degree of matching user preferences).

In some scenarios, multimedia used for playing is determined, in response to partially matching between the multimedia in the multimedia database and the semantic slot information of the request and based on a comprehensive priority of the matched semantic slot, from the multimedia partially matching the semantic slot information of the request, and guiding reply information to the voice playing request and/or recommendation information of the multimedia used for playing are fed back by voice based on the matched semantic slot, unmatched semantic slot and selected multimedia.

For example, a voice playing request inputs “ZXY's song, reggae,” and then the semantic slot information of the request “type: song,” “singer: ZXY,” and “style: reggae” are obtained. It is impossible to find multimedia completely matching the semantic slot information of the request from a multimedia database, but it is possible to find songs matching the “type: song” and “singer: ZXY,” and songs matching the “type: song” and “style: reggae”. Under the circumstance, a comprehensive priority of the matched semantic slots is calculated based on a preset weight of each slot, and then the multimedia used for playing is determined based on the comprehensive priority. For example, the comprehensive priority of the “type: song” and “singer: ZXY” obtained by calculation based on the weights of the preset slots is lower than that of the “type: song” and “style: reggae,” and then reply information to the voice playing request “fail to find reggae music of ZXY. You may listen to an XY band of reggae music. Do not stop ABCD” may be fed back by voice.

In some scenarios, a non-existence of multimedia used for playing is determined, in response to no matching between the multimedia in the multimedia database and the semantic slot information of the request and an expression of the voice playing request failing to comply with a predetermined rule, and instructing reply information on the expression of the voice playing request are fed back by voice.

For example, a voice playing request inputs “I'd like to listen to hofhfjfhqd's song,” and then semantic slot information of the request “type: song,” and “singer: hofhfjfhqd” or “style: hofhfjfhqd” and the like are obtained. Based on the semantic slot information of the request, a non-existence of multimedia used for playing is determined. Therefore, reply information to the voice playing request “Pardon, you may tell me you'd like to listen to XYZ (song name) of ZXY (singer name)” may be fed back by voice.

In some scenarios, multimedia used for playing is determined, in response to no exactly matching between the multimedia in the multimedia database and the semantic slot information of the request and based on inferred semantic slot information obtained from the semantic slot information of the request, and inferred reply information to an expression of the voice playing request and/or recommendation information of the multimedia used for playing are fed back by voice. Here, the inferred semantic slot information may be obtained from the semantic slot information of the request using a preset rule or a pre-trained inferring model.

For example, a voice playing request inputs “I'd like to listen to a song to which a person will listen when the person feels lonely,” and then semantic slot information of the request “type: song” and “singer: listening when feeling lonely” or “style: listening when feeling lonely” and the like is obtained. In a multimedia database, there is not multimedia accurately matching the semantic slot information of the request. Based on multimedia parameters, inferred semantic slot information “style: lonely” of inferred from the semantic slot information of the request “style: listening when feeling lonely” is determined, multimedia used for playing is determined, and reply information to the voice playing request “you might want to listen to lonely songs. You may listen to AB (song name) of XXX (band)” may be fed back by voice.

In some scenarios, a non-existence of multimedia used for playing is determined, in response to matching between the multimedia in the multimedia database and a partial slot in the semantic slot information of the request and a last semantic slot in the semantic slot information of the request being an unsupported semantic slot, or in response to no matching between the multimedia in the multimedia database and the semantic slot information of the request and the semantic slot information of the request comprising an unsupported semantic slot, and last-ditch reply information to the voice playing request is fed back by voice. The last-ditch reply information here is reply information preset based on the content of the unsupported semantic slot. The last semantic slot here refers to a last slot in the lexemes obtained by identifying a voice playing request.

For example, a voice playing request inputs “CBA (album name) of ZXY (singer name),” and then semantic slot information of the request “type: song,” “singer: ZXY,” “album: CBA” and the like is obtained. Based on the semantic slot information of the request, an existence of the songs of the singer ZXY in a multimedia database is determined, but a copyright of the album CBA is not available, and a non-existence of multimedia used for playing is determined. Therefore, reply information to the voice playing request “copyright of this album is not available yet. You may listen to ZXY DEF (album name)” may be fed back by voice.

For another example, a voice playing request inputs “replay the song,” and then semantic slot information of the request “type: song,” “song name: this one,” “playing request: replay” and the like is obtained. A last semantic slot “playing request: replay” is an unsupported semantic slot, and a non-existence of multimedia used for playing is determined. Therefore, reply information to the voice playing request “sorry, but this is not supported yet” may be fed back by voice.

Alternatively, for example, a voice playing request inputs “what musical instruments are here,” semantic slot information of the request “musical instrument: what kinds” and the like is obtained, including an unsupported semantic slot “musical instrument,” and a non-existence of multimedia used for playing is determined. Therefore, reply information to the voice playing request “sorry, but this is not supported yet” may be fed back by voice.

In some scenarios, multimedia including the probability of similarity matching between the multimedia and the semantic slot information of the request greater than the predetermined threshold being the multimedia used for playing is determined, in response to a probability of similarity matching between the multimedia in the multimedia database and the semantic slot information of the request being greater than a predetermined threshold, and advising reply information to the voice playing request and/or recommendation information of the multimedia used for playing are fed back by voice, based on the semantic slot information of the request and multimedia completely matching the semantic slot information of the request.

For example, a voice playing request inputs “love in C.E. AB,” which hits a semantic slot “song: love in C.E. AB”. However, a song hitting “song: love in A.D. AB” most similar to the semantic slot exists in a song database, a song hitting “song: love in A.D. AB” is determined to be multimedia used for playing, and then reply information to the voice playing request “what you'd like to hear is probably love in A.D. AB (song name) of ZXY (singer name)” may be fed back by voice.

In some scenarios, in response to the semantic slot information of the request comprising pieces of information satisfying a given semantic slot and based on results of individually matching between the multimedia in the multimedia database and a plurality of the semantic slots, a combination of each of the results of individually matching being the multimedia used for playing is determined, and reply information of the combination to the voice playing request is fed back by voice.

For example, a voice playing request inputs “ZXY (singer), LMN (singer) and CDF (singer),” semantic slots “singer: ZXY,” “singer: LMN” and “singer: CDF” are hit, and reply information to the voice playing request “carefully selected combined song list ZXY ABCD (song name)” is fed back by voice based on the results of individually matching between the multimedia in the multimedia database and a plurality of the semantic slots.

In some scenarios, multimedia used for playing is determined, in response to the semantic slot information of the request indicating playing favorite multimedia of a user and based on historical preference data of the user, and one or more of the following information items are fed back by voice: the reply information to the voice playing request, recommendation information of the multimedia used for playing, and guiding information on an expression of preferences.

For example, a voice playing request inputs “play some of my favorite songs,” which hits a semantic slot “song list,” and indicates playing favorite multimedia of a user. Multimedia YZGF used for playing is determined based on history preference data of a user, and then reply information to the voice playing request “OK. You may listen to YZGF (song name) of ZXY (singer name). When meeting a favorite song, you may tell me that you like this song” may be fed back by voice.

Step 240, playing the multimedia used for playing.

In this embodiment, multimedia used for playing may be played via a loudspeaker of a terminal device.

Optionally, in step 250, last-ditch reply information to the voice playing request and/or instructing reply information on an expression of the voice playing request in response to a lexeme of the voice playing request not matching a semantic slot.

In this embodiment, a lexeme of a voice playing request is not matched a semantic slot, and this function may be not supported yet. Therefore, last-ditch reply information about not supporting may be fed back by voice, and alternatively or additionally, instructing reply information on an expression of the voice playing request may also be replied.

A method for playing multimedia provided in the embodiments of the disclosure determines semantic slot information of a request based on a voice playing request of a user; determines multimedia used for playing, based on a result of matching between multimedia in a multimedia database and the semantic slot information of the request, and feeds back reply information to the voice playing request by voice; and finally plays the multimedia used for playing. In this process, finesorted multimedia used for playing is provided for different playing requests of users, and the reply information to the voice playing request is fed back by voice, thereby improving the accuracy of voice interaction, and the accuracy and pertinence in playing multimedia for users.

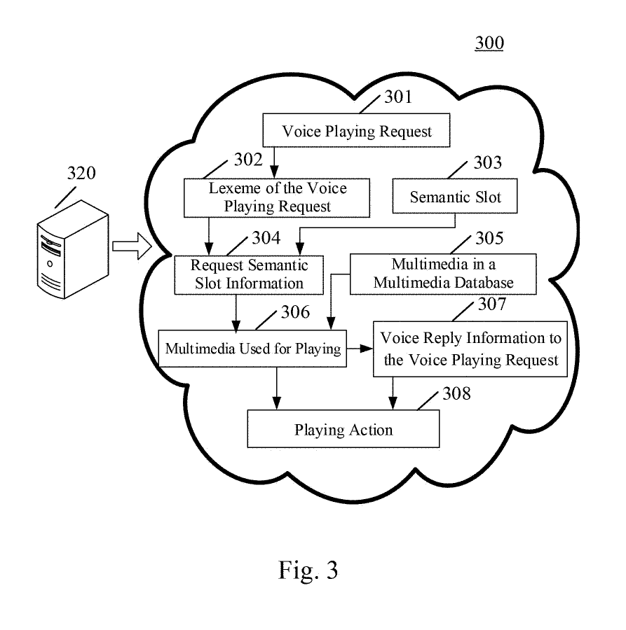

An illustrative application scenario of a method for playing multimedia according to the disclosure is described in conjunction with FIG. 3 below.

As shown in FIG. 3, an illustrative flowchart diagram of an application scenario of a method for playing multimedia according to the disclosure is shown.

As shown in FIG. 3, a method 300 for playing multimedia runs in a smart loudspeaker box 320, and may include:

firstly, receiving a voice playing request 301 inputted by a user;

then, identifying a lexeme 302 of the voice playing request 301;

then, matching between the lexeme 302 of the voice playing request 301 and a semantic slot 303 to obtain semantic slot information of the request 304;

then, determining multimedia 306 used for playing and voice reply information 307 to the voice playing request based on a result of matching between multimedia 305 in a multimedia database and the semantic slot information of the request 304; and

finally, executing a playing action 308 in response to the multimedia 306 used for playing and the voice reply information 307 to the voice playing request.

It should be understood that the method for playing multimedia shown in FIG. 3 is only an illustrative embodiment of a method for playing multimedia, but does not represent a limitation of the embodiments of the disclosure. For example, in response to the multimedia 306 used for playing and the voice reply information 307 to the voice playing request, a playing action 308 may be executed respectively by playing the multimedia 306 used for playing and feeding back the voice reply information 307 to the voice playing request by voice.

The method for playing multimedia provided in the application scenario according to the embodiments of the disclosure may improve the accuracy of voice interaction, and the accuracy and pertinence in playing multimedia.

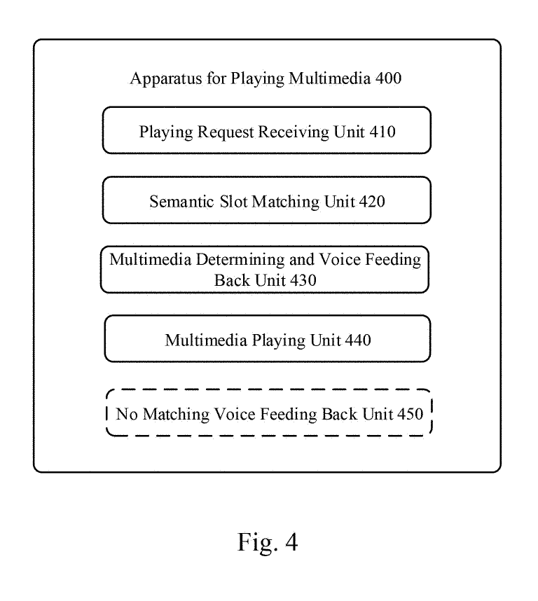

Further referring to FIG. 4, as implementation of the methods, the disclosure provides an embodiment of an apparatus for playing multimedia, and the embodiment of the apparatus for playing multimedia corresponds to the embodiments of the methods for playing multimedia shown in FIG. 1 to FIG. 3. Therefore, the foregoing operations and characteristics described for the methods for playing multimedia in FIG. 1 to FIG. 3 are also applicable to an apparatus for playing multimedia 400 and units included therein, and are not repeated any more here.

As shown in FIG. 4, an apparatus for playing multimedia 400 includes: a playing request receiving unit 410 for receiving a voice playing request inputted by a user; a semantic slot matching unit 420 for matching between a lexeme of the voice playing request and a semantic slot to obtain semantic slot information of the request; a multimedia determining and voice feeding back unit 430 for determining, based on a result of matching between multimedia in a multimedia database and the semantic slot information of the request, multimedia used for playing, and feeding back reply information to the voice playing request by voice; and a multimedia playing unit 440 for playing the multimedia used for playing.

In some embodiments, the multimedia determining and voice feeding back unit 430 is further used for: determining, in response to completely matching between the multimedia in the multimedia database and the semantic slot information of the request and based on the multimedia completely matching the semantic slot information of the request, the multimedia used for playing, and feeding back the reply information to the voice playing request and/or recommendation information of the multimedia used for playing by voice.

In some embodiments, the multimedia determining and voice feeding back unit 430 is further used for: determining, in response to partially matching between the multimedia in the multimedia database and the semantic slot information of the request and based on a comprehensive priority of the matched semantic slot, the multimedia used for playing from the multimedia partially matching the semantic slot information of the request, and feeding back guiding reply information to the voice playing request and/or recommendation information of the multimedia used for playing by voice based on the matched semantic slot, unmatched semantic slot and selected multimedia.

In some embodiments, the multimedia determining and voice feeding back unit 430 is further used for: determining, in response to no matching between the multimedia in the multimedia database and the semantic slot information of the request and an expression of the voice playing request failing to comply with a predetermined rule, a non-existence of multimedia used for playing and feeding back instructing reply information on the expression of the voice playing request by voice.

In some embodiments, the multimedia determining and voice feeding back unit 430 is further used for: determining, in response to no exactly matching between the multimedia in the multimedia database and the semantic slot information of the request and based on inferred semantic slot information obtained from the semantic slot information of the request, the multimedia used for playing, and feeding back inferred reply information to an expression of the voice playing request and/or recommendation information of the multimedia used for playing by voice.

In some embodiments, the multimedia determining and voice feeding back unit 430 is further used for: determining, in response to matching between the multimedia in the multimedia database and a partial slot in the semantic slot information of the request and a last semantic slot in the semantic slot information of the request being an unsupported semantic slot, or in response to no matching between the multimedia in the multimedia database and the semantic slot information of the request and the semantic slot information of the request comprising an unsupported semantic slot, a non-existence of multimedia used for playing, and feeding back last-ditch reply information to the voice playing request by voice.

In some embodiments, the multimedia determining and voice feeding back unit 430 is further used for: determining, in response to a probability of similarity matching between the multimedia in the multimedia database and the semantic slot information of the request being greater than a predetermined threshold, multimedia including the probability of similarity matching between the multimedia and the semantic slot information of the request greater than the predetermined threshold being the multimedia used for playing, and feeding back, based on the semantic slot information of the request and multimedia completely matching the semantic slot information of the request, advising reply information to the voice playing request and/or recommendation information of the multimedia used for playing by voice.

In some embodiments, the multimedia determining and voice feeding back unit 430 is further used for: determining, in response to the semantic slot information of the request comprising pieces of information satisfying a given semantic slot and based on results of individually matching between the multimedia in the multimedia database and a plurality of the semantic slots, a combination of each of the results of individually matching being the multimedia used for playing, and feeding back reply information of the combination to the voice playing request by voice.

In some embodiments, the multimedia determining and voice feeding back unit 430 is further used for: determining, in response to the semantic slot information of the request indicating playing favorite multimedia of a user and based on historical preference data of the user, the multimedia used for playing, and feeding back one or more of the following information items by voice: the reply information to the voice playing request, recommendation information of the multimedia used for playing, and guiding information on an expression of preferences.

In some embodiments, the apparatus 400 further includes: a no matching voice feeding back unit 450 for feeding back, in response to a lexeme of the voice playing request not matching a semantic slot, last-ditch reply information to the voice playing request and/or instructing reply information on an expression of the voice playing request by voice.

The disclosure further provides an embodiment of a system, including: one or more processors; and a storage device for storing one or more programs, where the one or more programs, when executed by the one or more processors, enable the one or more processors to implement the method for playing multimedia according to any one of the embodiments.

The disclosure further provides an embodiment of a computer readable storage medium storing computer programs, where the programs, when executed by a processor, enable to implement the method for playing multimedia according to any one of the embodiments.

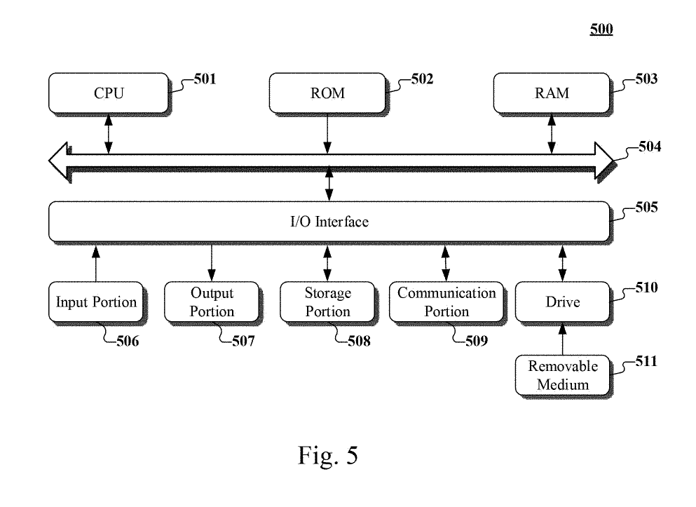

Below referring to FIG. 5, a schematic structural diagram of a computer system 500 of a terminal device or a server applicable for implementing the embodiments of the disclosure is shown. The terminal device shown in FIG. 5 is only an example, and shall not limit the functions and serviceable range of the embodiments of the disclosure in any way.

As shown in FIG. 5, the computer system 500 includes a central processing unit (CPU) 501, which may execute various appropriate actions and processes in accordance with a program stored in a read-only memory (ROM) 502 or a program loaded into a random access memory (RAM) 503 from a storage portion 508. The RAM 503 also stores various programs and data required by operations of the system 500. The CPU 501, the ROM 502 and the RAM 503 are connected to each other through a bus 504. An input/output (I/O) interface 505 is also connected to the bus 504.

The following components are connected to the I/O interface 505: an input portion 506 including a keyboard, a mouse etc.; an output portion 507 comprising a cathode ray tube (CRT), a liquid crystal display device (LCD), a speaker etc.; a storage portion 508 including a hard disk and the like; and a communication portion 509 comprising a network interface card, such as a LAN card and a modem. The communication portion 509 performs communication processes via a network, such as the Internet. A drive 510 is also connected to the I/O interface 505 as required. A removable medium 511, such as a magnetic disk, an optical disk, a magneto-optical disk, and a semiconductor memory, may be installed on the drive 510, to facilitate the retrieval of a computer program from the removable medium 511, and the installation thereof on the storage portion 508 as needed.

In particular, according to embodiments of the present disclosure, the process described above with reference to the flow chart may be implemented in a computer software program. For example, an embodiment of the present disclosure includes a computer program product, which comprises a computer program that is tangibly embedded in a machine-readable medium. The computer program comprises program codes for executing the method as illustrated in the flow chart. In such an embodiment, the computer program may be downloaded and installed from a network via the communication portion 509, and/or may be installed from the removable media 511. The computer program, when executed by the central processing unit (CPU) 501, implements the above mentioned functionalities as defined by the methods of the present disclosure.

It should be noted that the computer readable medium in the present disclosure may be computer readable storage medium. An example of the computer readable storage medium may include, but not limited to: semiconductor systems, apparatus, elements, or a combination any of the above. A more specific example of the computer readable storage medium may include but is not limited to: electrical connection with one or more wire, a portable computer disk, a hard disk, a random access memory (RAM), a read only memory (ROM), an erasable programmable read only memory (EPROM or flash memory), a fibre, a portable compact disk read only memory (CD-ROM), an optical memory, a magnet memory or any suitable combination of the above. In the present disclosure, the computer readable storage medium may be any physical medium containing or storing programs which can be used by a command execution system, apparatus or element or incorporated thereto. The computer readable medium may be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium including but not limited to: wireless, wired, optical cable, RF medium etc., or any suitable combination of the above.

The flowchart diagrams and the block diagrams in the accompanying drawings illustrate system structures, functions and operations that may be implemented by systems, methods and computer program products according to the embodiments of the disclosure. In this regard, each box in the flowchart diagrams or the block diagrams may represent a unit, a program segment, or a part of a code, and the unit, the program segment, or a part of the code contains one or more executable instructions for implementing a provided logical function. It should also be noted that in some modes of implementing the disclosure as alternatives, a function indicated in a box may also occur in an order different from that indicated in the accompanying drawings. For example, two consecutive boxes may actually be executed practically in parallel, and may sometimes be executed in a reverse order, depending on the functions involved. It should also be noted that each box in the block diagrams and/or the flowchart diagrams and a combination of the boxes in the block diagrams and/or the flowchart diagrams may be implemented using a special hardware based system for executing a specified function or operation or using a combination of special hardware and a computer instruction.

The units involved in the embodiments of the disclosure may be implemented by software or by hardware. The described units may also be arranged in a processor, for example, be described as: a processor including a playing request receiving unit, a semantic slot matching unit, a multimedia determining and voice feeding back unit, and a multimedia playing unit, and the names of these units do not limit the units per se in some cases. For example, the playing request receiving unit may also be described as “a unit for receiving a voice playing request inputted by a user.”

As another aspect, the embodiments of the disclosure further provide a non-volatile computer storage medium, which may be the non-volatile computer storage medium contained in the device according to the embodiments; and may also be a separate non-volatile computer storage medium that is not installed in a terminal. The non-volatile computer storage medium stores one or more programs, and the one or more programs, when executed by a device, enable the device to receive a voice playing request inputted by a user; match between a lexeme of the voice playing request and a semantic slot to obtain semantic slot information of the request; determine, based on a result of matching between multimedia in a multimedia database and the semantic slot information of the request, multimedia used for playing, and feed back reply information to the voice playing request by voice; and play the multimedia used for playing.

The above description only provides preferred embodiments of the disclosure and shows the applied technical principles. As will be appreciated by those skilled in the art, the scope of protection of the disclosure is not limited to the technical solution consisting of a specific combination of the technical characteristics, but should also cover other technical solutions consisting of any combination of the technical characteristics or equivalent characteristics thereof without departing from the inventive concept, such as the technical solutions formed by mutual substitutions of the above technical characteristics and the technical characteristics disclosed (but not limited to) in the embodiments of the disclosure and including similar functions.

What is claimed is:

1. A method for playing multimedia, the method comprising:
receiving a voice playing request inputted by a user;
matching between a lexeme of the voice playing request and a semantic slot to obtain semantic slot information of the request;
determining, based on a result of matching between multimedia in a multimedia database and the semantic slot information of the request, multimedia used for playing, and feeding back reply information to the voice playing request by voice; and
playing the multimedia used for playing,
wherein the method is performed by at least one processor.

2. The method according to claim 1, wherein the determining, based on a result of matching between multimedia in a multimedia database and the semantic slot information of the request, multimedia used for playing, and feeding back reply information to the voice playing request by voice comprises:
determining, in response to completely matching between the multimedia in the multimedia database and the semantic slot information of the request and based on the multimedia completely matching the semantic slot information of the request, the multimedia used for playing, and feeding back the reply information to the voice playing request and/or recommendation information of the multimedia used for playing by voice.

3. The method according to claim 1, wherein the determining, based on a result of matching between multimedia in a multimedia database and the semantic slot information of the request, multimedia used for playing, and feeding back reply information to the voice playing request by voice comprises:
determining, in response to partially matching between the multimedia in the multimedia database and the semantic slot information of the request and based on a comprehensive priority of the matched semantic slot, the multimedia used for playing from the multimedia partially matching the semantic slot information of the request, and feeding back guiding reply information to the voice playing request and/or recommendation information of the multimedia used for playing by voice based on the matched semantic slot, unmatched semantic slot and selected multimedia.

4. The method according to claim 1, wherein the determining, based on a result of matching between multimedia in a multimedia database and the semantic slot information of the request, multimedia used for playing, and feeding back reply information to the voice playing request by voice comprises:
determining, in response to no matching between the multimedia in the multimedia database and the semantic slot information of the request and an expression of the voice playing request failing to comply with a predetermined rule, a non-existence of multimedia used for playing and feeding back instructing reply information on the expression of the voice playing request by voice.

5. The method according to claim 1, wherein the determining, based on a result of matching between multimedia in a multimedia database and the semantic slot information of the request, multimedia used for playing, and feeding back reply information to the voice playing request by voice comprises:
determining, in response to no exactly matching between the multimedia in the multimedia database and the semantic slot information of the request and based on inferred semantic slot information obtained from the semantic slot information of the request, the multimedia used for playing, and feeding back inferred reply information to an expression of the voice playing request and/or recommendation information of the multimedia used for playing by voice.

6. The method according to claim 1, wherein the determining, based on a result of matching between multimedia in a multimedia database and the semantic slot information of the request, multimedia used for playing, and feeding back reply information to the voice playing request by voice comprises:
determining, in response to matching between the multimedia in the multimedia database and a partial slot in the semantic slot information of the request and a last semantic slot in the semantic slot information of the request being an unsupported semantic slot, or in response to no matching between the multimedia in the multimedia database and the semantic slot information of the request and the semantic slot information of the request comprising an unsupported semantic slot, a non-existence of multimedia used for playing, and feeding back last-ditch reply information to the voice playing request by voice.

7. The method according to claim 1, wherein the determining, based on a result of matching between multimedia in a multimedia database and the semantic slot information of the request, multimedia used for playing, and feeding back reply information to the voice playing request by voice comprises:
determining, in response to a probability of similarity matching between the multimedia in the multimedia database and the semantic slot information of the request being greater than a predetermined threshold, multimedia including the probability of similarity matching between the multimedia and the semantic slot information of the request greater than the predetermined threshold being the multimedia used for playing, and feeding back, based on the semantic slot information of the request and multimedia completely matching the semantic slot information of the request, advising reply information to the voice playing request and/or recommendation information of the multimedia used for playing by voice.

8. The method according to claim 1, wherein the determining, based on a result of matching between multimedia in a multimedia database and the semantic slot information of the request, multimedia used for playing, and feeding back reply information to the voice playing request by voice comprises:
determining, in response to the semantic slot information of the request comprising pieces of information satisfying a given semantic slot and based on results of individually matching between the multimedia in the multimedia database and a plurality of the semantic slots, a combination of each of the results of individually matching being the multimedia used for playing, and feeding back reply information of the combination to the voice playing request by voice.

9. The method according to claim 1, wherein the determining, based on a result of matching between multimedia in a multimedia database and the semantic slot information of the request, multimedia used for playing, and feeding back reply information to the voice playing request by voice comprises:
determining, in response to the semantic slot information of the request indicating playing favorite multimedia of a user and based on historical preference data of the user, the multimedia used for playing, and feeding back one or more of the following information items by voice: the reply information to the voice playing request, recommendation information of the multimedia used for playing, and guiding information on an expression of preferences.

10. The method according to claim 1, wherein the method further comprises:
feeding back, in response to a lexeme of the voice playing request not matching a semantic slot, last-ditch reply information to the voice playing request and/or instructing reply information on an expression of the voice playing request by voice.

11. An apparatus for playing multimedia, the apparatus comprising:
at least one processor; and
a memory storing instructions, the instructions when executed by the at least one processor, cause the at least one processor to perform operations, the operations comprising:
receiving a voice playing request inputted by a user;
matching between a lexeme of the voice playing request and a semantic slot to obtain semantic slot information of the request;
determining, based on a result of matching between multimedia in a multimedia database and the semantic slot information of the request, multimedia used for playing, and feeding back reply information to the voice playing request by voice; and
playing the multimedia used for playing.

12. The apparatus according to claim 11, wherein the determining, based on a result of matching between multimedia in a multimedia database and the semantic slot information of the request, multimedia used for playing, and feeding back reply information to the voice playing request by voice comprises:
determining, in response to completely matching between the multimedia in the multimedia database and the semantic slot information of the request and based on the multimedia completely matching the semantic slot information of the request, the multimedia used for playing, and feeding back the reply information to the voice playing request and/or recommendation information of the multimedia used for playing by voice.

13. The apparatus according to claim 11, wherein the determining, based on a result of matching between multimedia in a multimedia database and the semantic slot information of the request, multimedia used for playing, and feeding back reply information to the voice playing request by voice comprises:
determining, in response to partially matching between the multimedia in the multimedia database and the semantic slot information of the request and based on a comprehensive priority of the matched semantic slot, the multimedia used for playing from the multimedia partially matching the semantic slot information of the request, and feeding back guiding reply information to the voice playing request and/or recommendation information of the multimedia used for playing by voice based on the matched semantic slot, unmatched semantic slot and selected multimedia.

14. The apparatus according to claim 11, wherein the determining, based on a result of matching between multimedia in a multimedia database and the semantic slot information of the request, multimedia used for playing, and feeding back reply information to the voice playing request by voice comprises:
determining, in response to no matching between the multimedia in the multimedia database and the semantic slot information of the request and an expression of the voice playing request failing to comply with a predetermined rule, a non-existence of multimedia used for playing and feeding back instructing reply information on the expression of the voice playing request by voice.

15. The apparatus according to claim 11, wherein the determining, based on a result of matching between multimedia in a multimedia database and the semantic slot information of the request, multimedia used for playing, and feeding back reply information to the voice playing request by voice comprises:
determining, in response to no exactly matching between the multimedia in the multimedia database and the semantic slot information of the request and based on inferred semantic slot information obtained from the semantic slot information of the request, the multimedia used for playing, and feeding back inferred reply information to an expression of the voice playing request and/or recommendation information of the multimedia used for playing by voice.

16. The apparatus according to claim 11, wherein the determining, based on a result of matching between multimedia in a multimedia database and the semantic slot information of the request, multimedia used for playing, and feeding back reply information to the voice playing request by voice comprises:
determining, in response to matching between the multimedia in the multimedia database and a partial slot in the semantic slot information of the request and a last semantic slot in the semantic slot information of the request being an unsupported semantic slot, or in response to no matching between the multimedia in the multimedia database and the semantic slot information of the request and the semantic slot information of the request comprising an unsupported semantic slot, a non-existence of multimedia used for playing, and feeding back last-ditch reply information to the voice playing request by voice.

17. The apparatus according to claim 11, wherein the determining, based on a result of matching between multimedia in a multimedia database and the semantic slot information of the request, multimedia used for playing, and feeding back reply information to the voice playing request by voice comprises:
determining, in response to a probability of similarity matching between the multimedia in the multimedia database and the semantic slot information of the request being greater than a predetermined threshold, multimedia including the probability of similarity matching between the multimedia and the semantic slot information of the request greater than the predetermined threshold being the multimedia used for playing, and feeding back, based on the semantic slot information of the request and multimedia completely matching the semantic slot information of the request, advising reply information to the voice playing request and/or recommendation information of the multimedia used for playing by voice.

18. The apparatus according to claim 11, wherein the determining, based on a result of matching between multimedia in a multimedia database and the semantic slot information of the request, multimedia used for playing, and feeding back reply information to the voice playing request by voice comprises:
determining, in response to the semantic slot information of the request comprising pieces of information satisfying a given semantic slot and based on results of individually matching between the multimedia in the multimedia database and a plurality of the semantic slots, a combination of each of the results of individually matching being the multimedia used for playing, and feeding back reply information of the combination to the voice playing request by voice.

19. The apparatus according to claim 11, wherein the determining, based on a result of matching between multimedia in a multimedia database and the semantic slot information of the request, multimedia used for playing, and feeding back reply information to the voice playing request by voice comprises:
determining, in response to the semantic slot information of the request indicating playing favorite multimedia of a user and based on historical preference data of the user, the multimedia used for playing, and feeding back one or more of the following information items by voice: the reply information to the voice playing request, recommendation information of the multimedia used for playing, and guiding information on an expression of preferences.

20. The apparatus according to claim 11, wherein the operations further comprise:
feeding back, in response to a lexeme of the voice playing request not matching a semantic slot, last-ditch reply information to the voice playing request and/or instructing reply information on an expression of the voice playing request by voice.

21. A non-transitory computer storage medium storing a computer program, the computer program when executed by one or more processors, causes the one or more processors to perform operations, the operations comprising:
receiving a voice playing request inputted by a user;
matching between a lexeme of the voice playing request and a semantic slot to obtain semantic slot information of the request;
determining, based on a result of matching between multimedia in a multimedia database and the semantic slot information of the request, multimedia used for playing, and feeding back reply information to the voice playing request by voice; and
playing the multimedia used for playing.
